(19) United States
(12) Patent Application Publication
(10) Pub. No.: US 2013/0085890 A1
(43) Pub. Date: Apr. 4, 2013

(54) System and Method For Meeting Marketplace

(71) Applicant: Keren HIBLUM, Tel Aviv (IL)

(72) Inventor: Keren HIBLUM, Tel Aviv (IL)

(21) Appl. No.: 13/252,492

(22) Filed: Oct. 4, 2011

(51) Int. Cl. G06Q 30/00

(52) U.S. Cl. 705/26.35

(57) ABSTRACT

The invention provides an online platform performing as a meeting marketplace through which a client can locate an expert for the purpose of various interactions which generally involve transfer of information and/or services from the expert to the client. Examples include consulting, tutoring, therapy, software support, teaching and guiding. The invention enables the client to negotiate and communicate with experts and to pay for a meeting with an expert.

### BACKGROUND

1. Technical Field

Embodiments of the present invention relate generally to systems and methods for an online meeting and domain expert marketplace.

2. Description of Related Art

Generally people seek domain experts either through word of mouth, yellow pages, or internet search, and arrange meetings in an ad-hoc fashion either directly, through secretaries or by other appointment. The meetings are generally either in person or through phone connection.

However as will be appreciated such methods are somewhat inefficient, inter alia because the experts are not necessarily ranked in any coherent fashion and no marketplace for meeting is available. Hence, an improved method for an online meeting marketplace is still a long felt need.

### BRIEF SUMMARY

An aspect of the present invention provides a meeting marketplace comprising:
a. a networked server having a database of experts and clients;
b. each client and expert having account and card;
c. means for allowing clients and experts to search said database for clients and experts;
d. means for allowing clients and experts to determine specific meeting price and policy by means of meeting proposal;
e. means for allowing virtual meetings between experts and clients according to the meeting policy;
f. means for allowing of an automated protection and enforcement meeting policy;
g. means for billing said clients and payments to said experts according to the specific meeting price and policy;
whereby clients and experts can perform said meeting by means of an online marketplace.

It is further within provision of the invention to provide the aforementioned system wherein said means for allowing clients and experts to determine specific meeting price and policy by means of meeting proposal comprise of:
a. Means for allowing said client and expert to propose a meeting to one another;
b. Means for allowing said client and expert to negotiate meeting policy, date, time and duration;
c. Means for allowing said client to prepay;

The system of claim 1 wherein each expert's account contain one client card and at least one expert card.

The system of claim 3 wherein the expert cards having one full credentials card and multiple limited credentials cards for allowing multiple experts to access said accounts.

It is further within provision of the invention to provide the aforementioned system wherein said meeting is selected from the group consisting of: webinar, webinar event, media license.

It is further within provision of the invention to provide the aforementioned system wherein said cards further comprising means for displaying related cards.

It is further within provision of the invention to provide the aforementioned system wherein said cards further comprising means for displaying the shared information with one's card.

It is further within provision of the invention to provide the aforementioned system further comprising means for calculating and displaying cards integrity score.

It is further within provision of the invention to provide the aforementioned system wherein said means for allowing of an automated protection and enforcement meeting policy comprise of:
a. Means for allowing said client to prepay;
b. Means for keeping the prepayment as trustee for said client and expert;
c. Means for tracking and logging said implementation of the meeting;
d. Means for comparing and automated resolution of said implementation of the meeting with said meeting policy;
e. Means for distributing the payment as per the meeting policy and actual implementation of the meeting.

It is further within provision of the invention to provide the aforementioned system wherein said meeting is prearranged and performed after said client and expert negotiated said meeting policy.

It is within provision of the invention to provide a method of connecting experts with clients comprising steps of:
a. providing a networked server having a database of experts and clients;
b. providing each client and expert having account and card;
c. allowing clients and experts to search said database for clients and experts;
d. allowing clients and experts to determine specific meeting price and policy by allowing of meeting proposal;
e. allowing virtual meetings between experts and clients according to the meeting policy;
f. allowing of an automated protection and enforcement meeting policy;
g. billing said clients and payments to said experts according to the specific meeting price and policy;
whereby clients and experts can perform said meeting by means of an online marketplace.

It is further within provision of the invention wherein said means for allowing clients and experts to determine specific meeting price and policy by means of meeting proposal comprise of:
a. allowing said client and expert to propose a meeting to one another;
b. allowing said client and expert to negotiate meeting policy, date, time and duration;
c. allowing said client to prepay;

It is further within provision of the invention wherein each expert's account contain one client card and at least one expert card.

It is further within provision of the invention wherein the expert cards having one full credentials card and multiple limited credentials cards for allowing multiple experts to access said accounts.

It is further within provision of the invention wherein said meeting is selected from the group consisting of: webinar, webinar event, media license.

It is further within provision of the invention wherein said cards further comprising means for displaying related cards.

It is further within provision of the invention wherein said cards further comprising means for displaying the shared information with one's card.

It is further within provision of the invention further comprising means for calculating and displaying cards integrity score.

It is further within provision of the invention wherein said means for allowing of an automated protection and enforcement meeting policy comprise of:
a. Means for allowing said client to prepay;
b. Means for keeping the prepayment as trustee for said client and expert;
c. Means for tracking and logging said implementation of the meeting;
d. Means for comparing and automated resolution of said implementation of the meeting with said meeting policy;
e. Means for distributing the payment as per the meeting policy and actual implementation of the meeting.

It is further within provision of the invention wherein said meeting is prearranged and performed after said client and expert negotiated said meeting policy.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a system diagram of the invention;

FIG. 2 illustrates an expert card; and

FIG. 3 illustrates a search capability of the system.

FIG. 4 illustrates a flow chart of the systems operation.

FIG. 5 illustrates a flow chart of the systems operation.

FIG. 6 illustrates a flow chart of the systems operation.

FIG. 7 illustrates a flow chart of the systems operation.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for an expert marketplace.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g., 1, 5, or 10).

The term ‘User’ refers hereinafter to any (i) viewer, visitor or user of the system, (ii) any individual or entity that creates an account with the system.

The term “Account” refers hereinafter to a set of parameters and characteristics describing an entity of the invention, said entity may contain one client card and may contain expert cards.

The term “Card” refers hereinafter to a particular embodiment of an account, whereby a particular instantiation of parameters is implemented. A certain card may describe a Client or a an Expert and it's properties will be defined accordingly.

The term “Client” refers hereinafter to a User who pays for Meeting marketplace Services or any other services and/or products which are available on the Site.

The term “Expert” refers hereinafter to a User who provides Meeting marketplace Services on the Site for payment.

The term “Prepay” refers hereinafter to the actions taken by the client and system in which the client provide the system with payment enabling information and allowed amount for charging, such as providing credit card details, bank authorization form, paypal details and authorization and his/her approval for future charging of amounts that are less than or equal to the requested amount using said payment enabling information.

The term “Meeting” refers hereinafter to a connection between at least one client with at least one expert (generally networked and involving video, audio, remote controlling of computers or the like) occurring for the provision of on-line services to the Client(s). A meeting, for example, may be a video and audio connection between a client and an expert, a webinar, a webinar event, a client viewing a prerecorded media for which he acquired a media license, etc.

The term “Meeting Proposal” refers hereinafter a suggestion made by the expert or client regarding the date, time, duration and purpose of the meeting as well as the meeting's price & policy and any other required information.

The term “Meeting Policy” and “Meeting Price & Policy” refers hereinafter to a Meeting price and policy that may include the Meeting price, Absence/Cancellation Fee, Cancellation and/or Last minute cancellation, advanced notice, the Waiting Duration and other details which are included in Meeting Proposal (as such terms are defined above) that is confirmed by the Expert and prepaid by the Client.

The term “Last Minute Cancellation” refers hereinafter to cancellation of a scheduled Meeting less than cancellation advance notice time before its scheduled time, or such different time period, as agreed in the Meeting Price & Policy.

The term “Waiting Duration” refers hereinafter to the time period measured from the scheduled Meeting start time in which the Expert is required to join the Meeting and the time period, following joining the Meeting that the Expert is required to stay connected await Client to call the Meeting.

The term “Client Absence”, “Absence” and “Absent” refers hereinafter to the situation wherein the Client does not press on the Meeting call button even though Expert has joined the respective Meeting during the Waiting Duration specified in the applicable Meeting Price & Policy.

The term “Paused” refers hereinafter to when a Meeting disconnects in a way other than via the close button, such Meeting status is “Paused”.

The term “Webinar” refers hereinafter to a seminar conducted via a network. Usually a live presentation, lecture or workshop that happens in real time, as users participate through various communication means such as chatting, video-chatting, file-sharing, or asking questions with a microphone.

The term “Webinar event” refers hereinafter to a type of meeting which is an interactive, real-time, with multiple participants, webinar taking place in a certain date and hour.

The Term “Media License” refers hereinafter to a permission to view an expert's prerecorded media, such as a webinar, video or audio for a limited time.

The invention provides an online platform for meeting marketplace wherein a client can locate an expert or expert can locate client request for the purpose of meeting proposal, private meetings, webinar registration and media licensing which leads to a various interactions which generally involve transfer of information and/or services from the expert to the client. Examples include consulting, tutoring, therapy, software support, teaching and guiding (“meeting marketplace service”). The invention enables the client and expert to negotiate and communicate as well as to prepay for the meeting prior to the meeting.

The invention thus comprises a sort of online experts' meeting marketplace. In this marketplace users may contact various experts to arrange billed video and/or audio counseling, private meetings, webinars, presentations and the like where clients from around the world can find a set of rated experts in a variety of disciplines. These experts may be contacted through the site to arrange an online video-based or other meeting.

Users of the system are Clients and Experts, the former desiring expert consultation and the latter providing it. Each of these are characterized insofar as the system is concerned by an ‘Account’ and a ‘Card’. The account is a basic set of identifying characteristics such as name, age, location, website, email, financial details, other contact information, description, currency preference, time zone and the like. Said characterizations control the behavior of the cards related to said account. The Card is a description of the user insofar as he/she operates as a client or expert, describing for instance desired or extant expertise, respectively.

Since the account is the basic identification of the client or expert, it may describe a natural person or any legal entity and each account may contain one or more cards describing person or positions under the account. Each card may be comprised of information such as contact info, name, age, occupation or occupation requirements, work experience or work experience requirements, certifications and authority to practice, education or education requirements, other resume information, fields of expertise or requirements, fields of interest or requirements, references or requirements, links, calendar, related cards, feedbacks, integrity, messages, meetings, webinars, transactions and the like.

Said Feedbacks are reviews by other system users—a Client may review or rate an Expert with whom he has consulted, and likewise an Expert may review or rate a Client with whom he has given consultation.

Said integrity rating will be calculated by the system's automatically collection of statistics of the client's and expert's information and past meetings, for example, cards total hours of activity in relation to the card's amount of disputes, cancellations, absences etc. These reviews and/or ratings may be included on a system users Card such that others may peruse them to arrive at informed decisions.

Said card contains the user's calendar in which his prepaid meeting and webinars are presented. Said presentation may be presented in two modes, the card user local time and the viewer's local time. Said card may further comprise communication means such as “send message”, “start a chat” and “propose a meeting” buttons or links.

Said Expert card may contain webinar events and media registration or prepaying forms.

Each said card may present the card's viewer a list and hyperlinks to related cards, for example, all the cards relating to the same account.

The invention further may comprise a user interface that enable one to see only shared information and activities with one's card. For example, when an expert views client's card he may browse to a “shared folder” in which he will see the client's calendar showing only their shared meetings, messages, requests etc. Similarly, said client may view his shared transactions while viewing the expert's card.

The invention further may comprise a search engine that will allow expert to search for client's requests and for clients to search for experts filtered by all of the card's characters, for example, location, authority to practice, prices, expertise, currencies, integrity, feedback and a like.

Said account may contain several expert cards, each card may relate to a specific expert's name and/or domain. Each said card will have it's own rates, integrity score, feedbacks and other characteristics as described above.

The invention provides a safe forum whereby Clients and Expert can agree on meeting particulars whereby the system of the invention allows protection of both parties by enforcing the meeting's particulars such as attendances and payments.

The experts that may be listed or otherwise use the system may in some embodiments of the invention be chosen for their standing in their respective fields. In other embodiments of the invention any expert desiring to be listed or otherwise use the system may sign up for registration, and will in fact be registered pending for example certain background checks. It is within provision of the invention that after meetings, Experts may be reviewed by the Users who have interacted with them, and vice versa. This allows for a reliable ranking or reputation to be built up over time whereby users can choose Experts based not only on price but on others' opinions of the services rendered (such as feedbacks) and the calculated integrity.

The invention further comprises the option for Users to purchase a limited, revocable, non-exclusive, non-transferable, personal license to access certain professional media or online seminars published by a given Expert.

In order to schedule a meeting between expert and a client, the client or the expert, as applicable, is required to click on a “Propose a Meeting” button or the equivalent. After clicking on such a button, the client or expert, as applicable, shall be required to complete such meeting's proposed Meeting Policy determining terms that include, inter alia, the following details:
a. Date and time of the meeting
b. Duration
c. Meeting price,
d. Absence/Cancellation fee
e. Cancellation advance notice
f. Waiting Duration

If the Meeting Proposal was submitted by the Expert to the Client, the Client can either modify the Meeting Proposal received by the Expert and send to the Expert a modified Meeting Proposal, or confirm the Meeting Proposal sent by the Expert by prepaying for the Meeting.

In parallel fashion, if the Meeting Proposal was submitted by the Client the Expert can either confirm such Meeting Proposal, or modify the Meeting Proposal received by the Client and resend to the Client the modified Meeting Proposal. Only once the expert confirmed the meeting proposal the client can prepay. Unless a Meeting Proposal was confirmed by an Expert and prepaid by the Client, they both may schedule other Meetings at the same time. If a Meeting Proposal is confirmed by the Expert and the Client prepaid for the Meeting then the agreed-upon Meeting shall be captured in both Expert's and Client's calendars. Such an approved Meeting Proposal becomes an official “Meeting Price & Policy”. Hence, the agreed time and date now block said client and expert form scheduling another meeting at the same time and become a formal contractual commitment. A meeting that is not preapproved will still be considered a part of the proposal.

This policy is not immutable but certain rules are provided dealing with changes and/or cancellation thereof. The Expert may, at any time, cancel or reschedule a prepaid Meeting without any liability or financial penalty. The Client is subject to terms set forth in the Meeting Price & Policy including such Meeting's cancellation and rescheduling terms. Said changes and/or cancellation might harm the integrity score of the expert.

An Expert will generally publish his/her going rates, for instance an hourly rate or rate per meeting. For clarity, an Expert's prices or other terms which are published on an Expert's Card shall be considered only as an average or offered price and shall not be considered as a binding offer.

A meeting with a domain expert is in essence a commodity, which the invention trades in. The meeting proposal is therefore a commercial proposal, having auxiliary processes that track both sides' implementation of their respective commitments. This information is used for billing decisions, integrity scores, and the like.

When a client wants to meet an expert, the client does not necessarily have to wait for the expert to be online simultaneously; the client can propose a meeting either by sending a message or meeting proposal to the Experts meeting inbox which is provided for this purpose, or by posting a request on his card or an electronic bulletin board provided for the purpose of receiving a meeting proposal from experts, or otherwise as will be clear to one skilled in the art.

In order to obviate possible problems due to no-shows, last minute cancellations and the like, all meetings will be specified as having an explicit and agreed-upon cancellation policy. The cancellation policy may be for instance involve the determination of an absence/cancellation fee, Cancellation advance notice period and associated penalties, and waiting duration. The cancellation policy may also take into account situations such as disconnections, which as will be appreciated may be either intentional or otherwise.

It is further within provision of the invention that the system track both client and expert attendance to determine actual meeting price. In another embodiment of the invention the Expert sets a fixed price (e.g. per hour or per meeting), while in yet another embodiment of the invention the client posts a desired target price. It is within provision of the invention that a sort of barter may occur, whereby offers for prices may be parried until an agreement is reached.

If no cancellation policy has been explicitly set or were defined that there is no cancellation policy, and there is a cancellation or absence scenario then no charge is levied, in some embodiments of the invention. Rather, attendance or lack thereof is reported on each card at integrity section.

It is within provision of the invention that software associated with the meeting marketplace log and report data such as number of cancellations, absences, meetings executed and other parameters.

If a particular meeting doesn't have a cancellation policy then the actual price may be determined by the counter state, as amplified below.

If a meeting does in fact have a cancellation policy, and a cancellation/absence/unexpected disconnection scenario occurs then the consequences will be determined according to the cancellation policy.

It is within provision of the invention that Experts and clients be represented by cards which list such information as background, fields of expertise and/or interest, hourly rates desired, references, links, and the like.

It is within provision of the invention that an expert or client may propose a meeting with a different hourly rate than is posted on the Expert Card. The initial price and meeting policy as appearing on the expert's card may be determined by default, and in some embodiments of the invention are negotiable.

If an expert confirms a meeting to a client and the client does not prepay (i.e. does not pay before the meeting) then the following policy may be followed: a meeting is not scheduled and listed on the calendar of the inventive method until the client prepays it. Theoretically an expert can confirm several meetings on the same calendar slot, and the first client that prepays on it will capture the slot.

The actual charge is determined after the meeting time (whether it occurs or not) and under terms determined by the invention resolution billing system.

It is within provision of the invention that an expert is able to cancel a prepaid meeting any time without any penalty. In some embodiments of the invention the client will not be charged nor compensated in this situation.

It is within provision of certain embodiments of the invention that a client be able to cancel a preapproved meeting any time without any compensation.

It is within provision of the invention that only meetings with no explicitly agreed-upon absence \cancellation\disconnect policy may be cancelled any time with no compensation.

The disconnect policy may comprise terms including the show terms, show duration, wait duration, no-show fee, disconnect fee, cancellation fee (if any), and the like. These terms may be mutual or distinct, such that a no-show, disconnecting or stopping on the part of the expert has different conditions than a no-show on the part of the client, for instance.

Meetings with an absence\cancellation policy can be cancelled according to said policy which may be time dependent. If for instance a meeting has a 1 day cancellation advance notice policy then the client can cancel anytime earlier then 1 day (24 hour period) before its scheduled time without any penalty; otherwise, he/she will be charged for a predetermined cancellation Fee.

It is within provision of the invention that a preapproved meeting may be reschedule contingent upon agreement between client and expert, either one of whom may suggest to reschedule a meeting. The new meeting date will then come into force after both confirm the tentative date (which may be suggested be either party); otherwise they are committed to the original date.

It is within provision of the invention that a meeting may commence at a time different from its scheduled time. For example, if both client and expert are available to start a preapproved (or paused or deferred) meeting any time before or after its scheduled time, they can do so from the preapproval time up to a given grace period after the scheduled time. For example the grace period may be 48 hours, in which case the parties involved have 48 hours after the scheduled meeting time to meet or reschedule, after which point the meeting is considered cancelled.

Once the parties (client and expert) connect to a meeting, all billing decisions are taken under the assumption that the meeting date is has been rescheduled to the actual meeting date and time.

It is within provision of the invention that a counter start to demark elapsed time once a client called a meeting, a video window, chat window, video window or other communications means allowing him/her receipt of data.

The current bill and elapsed time are updated for example after each elapsed minute. It is within provision of the invention that if a client disconnects during a meetings' first 59 seconds, for example, he/she is not charged unless there is an absence\cancellation policy explicitly to the contrary. If the expert disconnects, the client is charged based upon the elapsed time and any fixed charges agreed upon.

Policies for dealing with unintentional disconnection by either the client or the expert are provided for explicitly, generally before the meeting time, by means of explicit agreement therefor. When a meeting is disconnected unintentionally, then its elapsed-time counter freezes and the meeting status is changed to “Paused”.

A paused meeting is a meeting that has experienced an unintentional disconnection by either the client or the expert. Both expert and client can rejoin the meeting any time during the next graced period (for example 48 hours), or reschedule the meeting (contingent upon confirmation by both parties). Paused meetings that are not rescheduled are automatically closed after the grace period as specified by terms made explicit in various agreements between users, experts, and the system operators.

It is within provision of the invention that a client may stop the link in the middle of a meeting, at any time in its duration. The client will in this case be charged based on elapsed time unless there is an absence\ cancellation policy to the contrary.

It is within provision of the invention that an expert may stop the link in the middle of a meeting, at any time in its duration. The client will in this case be charged based on elapsed time.

It is within provision of the invention that an absence\ cancellation fee be charged in certain cases. This may be calculated based upon the percentage of the meeting price that is automatically charged on the following scenarios:
a. When the client cancels a meeting in less than Cancellation advance notice period. Any longer-term notice is not accrued to the cancellation Fee.
b. When the client is absent from a meeting but the expert attends the meeting. For example, in case the client did not use the “call” button and the expert attended for the entire waiting duration as agreed upon.
c. When a client stops a meeting when the elapsed time is lower than the cancellation fee amount. When an expert stops the meeting the meeting price will be calculated according to the elapsed time.
d. When a meeting that was paused at the behest of the client side and was not rescheduled or continued in the grace period, and the elapsed time is lower than the absent\last minute cancellation amount. Any disconnection from the expert's side causes the meeting price according to the elapsed time.

An expert is considered absent from a meeting when he/she does not comply with the meetings' waiting duration terms. These may specify for instance that the expert must log into the meeting, by pressing the “join” button, associated with the method within at most 10 minutes after the scheduled meeting time and/or remain logged-in for at least 10 minutes after the his/her's actual joining time regardless of the client's appearance or lack thereof.

On the other hand when the expert complies with the wait duration he/she is considered to have attended the meeting in good faith. The system may further allow a visual representation allowing the expert to keep track of his/her waiting duration compliance, for example by showing a time counter until the end of the waiting duration and once the waiting duration is over by showing a different visual marker.

For example for a meeting set for 6 pm with a waiting duration of 10 minutes and a wait duration of 10 minutes, the expert must join the meeting by 6:10 pm and stay connected for at least 10 minutes, whereupon if the client has not shown the expert may leave with no penalty. In this latter case, the expert is considered absent from the above meeting on the following scenarios:
a. if he/she joined the meeting at 6:11 pm
b. if he/she joined the meeting at 6:01 and stayed connected only until 06:10 (instead of at least 06:11)
c. if he/she joined the meeting at 5:59 and stayed connected only until 06:09

In another embodiment of the invention, the waiting period is counted only from the actual Expert's attending hour.

The client is considered absent if he/she doesn't use the “call” button and expert complied with the waiting duration.

Money is transferred to the expert account immediately when either of the following happens:
a. A meeting ends automatically at the end of its duration
b. The client or expert stops the meeting before the end of its duration
c. The client stops a paused meeting
d. Prepaid or paused meeting past the grace period (for example 48 hours) with no reconnecting or rescheduling is automatically closed by the system.

The closing charges (for Client and/or Expert) takes place under the aegis of a resolution billing system. Preapproved and paused meetings that pass the grace period and have absence\cancellation policies in effect will be resolved in accordance with this policy.

It is within provision of the invention to utilize an automated resolution system adapted for comparing implementation of the meeting with the meeting's policy and resolving conflicts that may arise. Such conflicts may include parameters such as counter stage, disconnection and cancellation fee, etc.

The site of the invention is adapted to hold the client's prepayment amount, in order to encourage both client's and expert's implementation of the meeting commitment.

One common scenario that may breed conflict is when a meeting does not have a specific absence\cancellation policy. In such cases a default policy may be implemented, wherein (for example) the meeting cancellation fee is some standard fixed amount.

When a meeting does have an absence\cancellation policy then the resolution billing system that takes into consideration the following parameters to decide on the actual charges levied:
a. Expert attendance
b. Client attendance
c. Client advance notice cancellation
d. Expert disconnecting
e. Client disconnecting
f. Expert stopping
g. Client stopping
h. Meeting price
i. Cancellation fee
j. Counter

It is further within provision of the invention to allow experts to publish via the meeting marketplace a webinar, which may be pre-recorded or real-time and may be available constantly or only in a certain date and time. The webinar may be directed to single client or to a group of clients.

It is further within provision of the invention that the webinar event would have a certain topic, date and time, registration price and would be directed to the general public or by invitation audience. Said client may registered to said event by prepaying the requested price and the system may charge the client only once the event successfully ended either if the client attended in the webinar or not. Event will considered as ended successfully if the expert was connected and broadcasting for the minimum duration of time as published by him/her and as long as the event was not reported as not successful by participating clients.

It is further within the provision of the invention that the system, in case of a webinar, will track only the expert's commitments both by its means and using the client's reports.

It is further within the provision of the invention that a client may purchase a non-exclusive, time limited, license to view or hear a pre-recorded media which was published by an Expert. Said license require payment before access is granted regardless wheatear the client actually used said license. Said published media may be a lecture, a lesson etc.

Experts may publish such event and webinar in a manner as described regarding expert's cards and clients may find said webinar in a manner as described regarding finding experts.

Clients may be required to buy a participation ticket in a manner as described regarding client-expert meeting, as per the expert's decision or as agreed between the publishing expert and a client. As the number of participants is limited, the purchased ticket will ensure an open slot in the event and the system will not allow others to use said slot even in case the client will not participate in the event.

Account may be nested. Thus an account may contain one client card and lots of expert card (for example, in case that the master user is a business with many employees functioning as experts). This is of use for example when the client is the master user. Experts can be assigned to limited credentials/access to the account. For example, allowing employees to access only certain experts cards, each managed by a different employee having different names, expertise or domain and without allowing them to purchase services via the account's client card or perform actions in unauthorized cards.

When a user first registers with the site running software associated with the invention, the user is issued his client card.

The user is automatically assigned a client card and additionally he can also be listed as an expert, by opening one or more experts' cards. Thus a user does not need separate accounts for expert and client ‘personalities’ but can act in both modes and have incoming money and outgoing money on the same account.

A user can have more than one expert card, for example an account for his firm and cards for himself and his employees. These cards may both be kept under a single account while all incoming amounts are input to one financial account. Each expert card can have a unique name, including expertise, prices and preferred policies. These are all kept under the same master account with the financial institution and invoice details assigned to it.

It is within provision of the invention that the account holder can create direct credentials for a specific expert card that limits access to that expert card only, not allowing access to any other card of the account. This means that (for example) the expert cannot use the client card, and thus cannot pay for meetings nor webinars of other experts, nor can he obtain access to other experts cards of this account.

Fee Collection is provided for under certain embodiments of the invention. Said fee may be, under certain embodiments of the invention, a percentage of the final price.

Private messages between users, such as between two clients, between two experts, or between a client and an expert, are facilitated in certain embodiments of the invention.

For example, if one is a registered user with an account, one may send and receive private messages to and from other registered users of the site. Any information that one sends within such messages is visible only to the message recipient(s). Said messages may be viewed by all the recipients and sender while each of them views the shared folder in each of their cards.

It is within provision of the invention that a feedback rating be reported, by clients concerning expert and potentially vice versa. The expert is aware that the client has access to his historical feedback rating, and will be capable of affecting this rating; the Client can rate and/or review his attended Meetings and Webinars. The feedback rating results of each expert will be visible to all users of the system but for the Personal Information (including name) of the Client that provided the feedback rating. Thus the rating client's identity is not revealed and will not be visible to other Users (except, in certain embodiments, for the Expert being rated).

It is within provision of the invention to use tracking technologies which track the User cards activities on the system and display the following details on the user card's integrity folder which may in some cases be visible to any users or visitors of the system. Various statistics may be compiled including but not limited to:
a. The total meeting durations for all meetings conducted using a certain card
b. Number of disputes that various a certain was involved in
c. Number of meetings a particular card has cancelled
d. Number of times this card was absent from Meetings
e. Meeting duration average vs. planned duration average
f. Number of disconnections that a certain card experienced

It is within the provision of the invention that a ranking formula will calculate a “system score” that consists on the card's feedbacks and integrity score.

Clients may enter a request using a website associated with the invention for the purpose of searching for applicable experts in various domains and/or sub domains. The Site's systems shall then automatically search for the match category and/or sub category and send those matched Experts a private message and email notification. Such matched Expert may contact the Clients in order to offer their Expert Service.

Email Notifications may be used to inform users concerning certain activities, such as meeting notices, proposed meetings, messages, information coming from channels or forums the user has subscribed to, or which relate to the user. We note that some actions on the site, such as receiving private messages, information regarding proposed or scheduled meetings, client requests (as specified above), and others may be sent automatically to a user. We further note that some notifications, such as a notification for receiving a private message, may be enabled by default. It is within provision of the invention that users can remove email notifications by means of account configuration provisions adapted for such purpose.

It is further within provision of the invention that the Expert Marketplace Service of the invention does not screen or edit the content of communications between Experts and Clients. The communications between Clients and the Experts are personal and private provided that Client may use such communication (including recording the Meeting) for personal purposes.

It is further within provision of the invention to require the experts to process received information in compliance with a predetermined Privacy Policy. The site associated with the invention may use reasonable commercial efforts to limit the use of such information and to use other appropriate confidentiality and security measures. It is further within provision of the invention that the site not guarantee the absolute security of any information flowing through the system, absolving the system of liability for any acts or omissions of Experts.

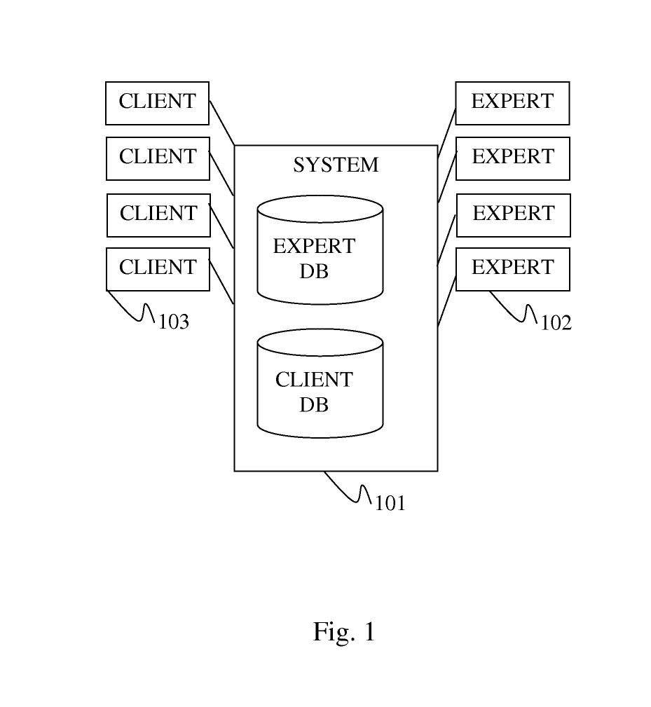

We now further explain the invention with reference to FIG. 1. Here the system 101 is shown which comprises a server that is on a network such as the internet. A number of clients 103 may be connected at any given time as may a number of experts 102. The system 101 comprises both expert and client databases and provides for connections and contact therebetween, for example allowing clients and experts to set up meetings as well as conduct them in the form of video conferences, webinars, text interaction, audio and the like.

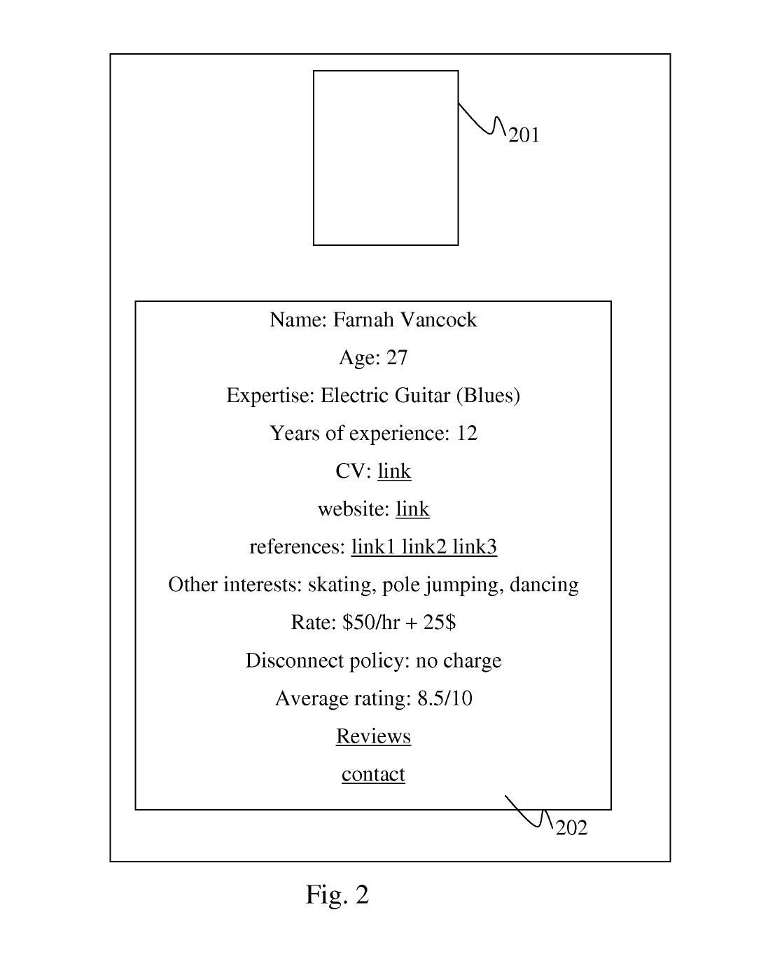

FIG. 2 presents an expert's card, which shows a picture 201, and a list 202 of attributes including name, age, years of experience, links to CV, link to website, link to references, a list of other interests, the rate charged, the disconnect policy desired, an average rating, a link for reviews, and a link to contact.

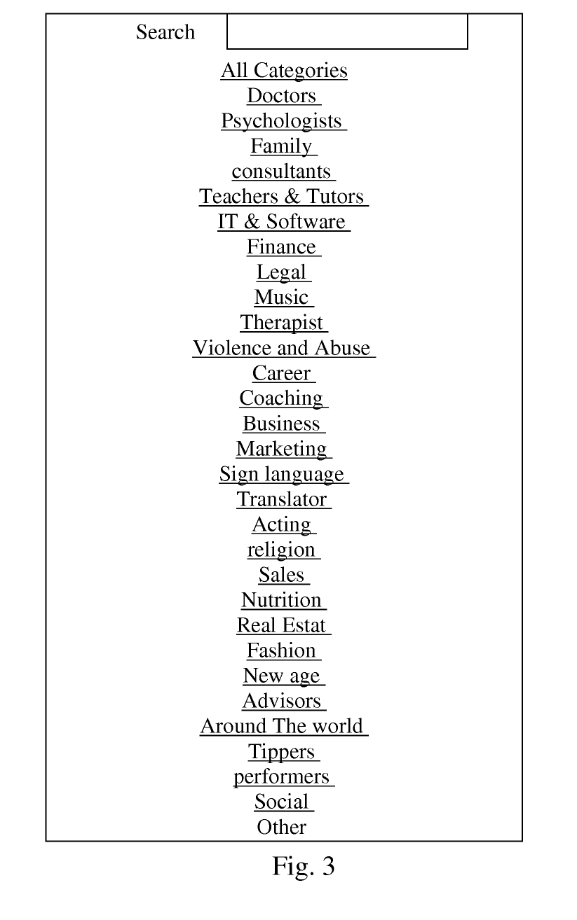

FIG. 3 shows a possible layout of a search page associated with the system, whereby a potential client can browse the expert listings to find an appropriate expert. Thus a list of categories is provided for search by category, as well as a free-text search box. The categories may comprise any in which expertise may be sought including but not limited to: Doctors, Psychologist, Family consultants, Teachers & Tutors IT & Software, Finance, Legal, Music, Therapist, Violence and Abuse, Career Coaching, Business Marketing, Sign language, Translator, Acting, religion, Sales, Nutrition, Real Estate, Fashion, New age, Advisors, Around The world, Tippers, performers, Social and the like.

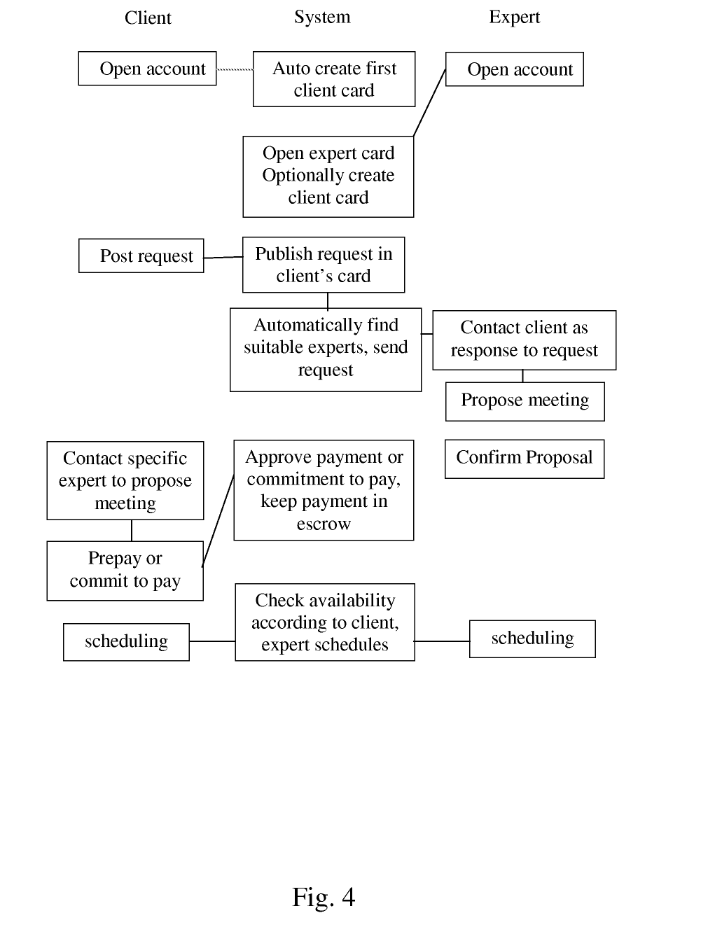

FIG. 4 indicates the actions taken by the various parties as they carry out the actions of starting system accounts and contacting each other. The client opens an account by means known in the art such as providing username, password and associated information. The system creates a first client card for the account in this case. When an expert opens an account a client card is similarly created, and is given the option to open an expert card.

The step of finding an expert may be initiated by means of a client posting a request. The system in this case will publish the request in the client's card, index said request for searching purposes, automatically find suitable experts based on search algorithms of the method, and send the request to these experts. The expert can in return contact a client as a response to the request and propose a meeting.

Alternatively, the client can contact a specific expert and propose a meeting, to which the expert can in turn reply.

Each proposal may be negotiated by the parties until the express confirm and the client prepay there will be no obligation of the parties.

The client may prepay. In this case the system will either approve the payment or commitment, and keep the payment or other surety as trustee between the parties.

Scheduling of the meeting occurs by means of the system checking the client's and expert's schedules to find an appropriate meeting time.

Said means may allow the checking of all cards associated with the client's or expert's account, according to the account configuration.

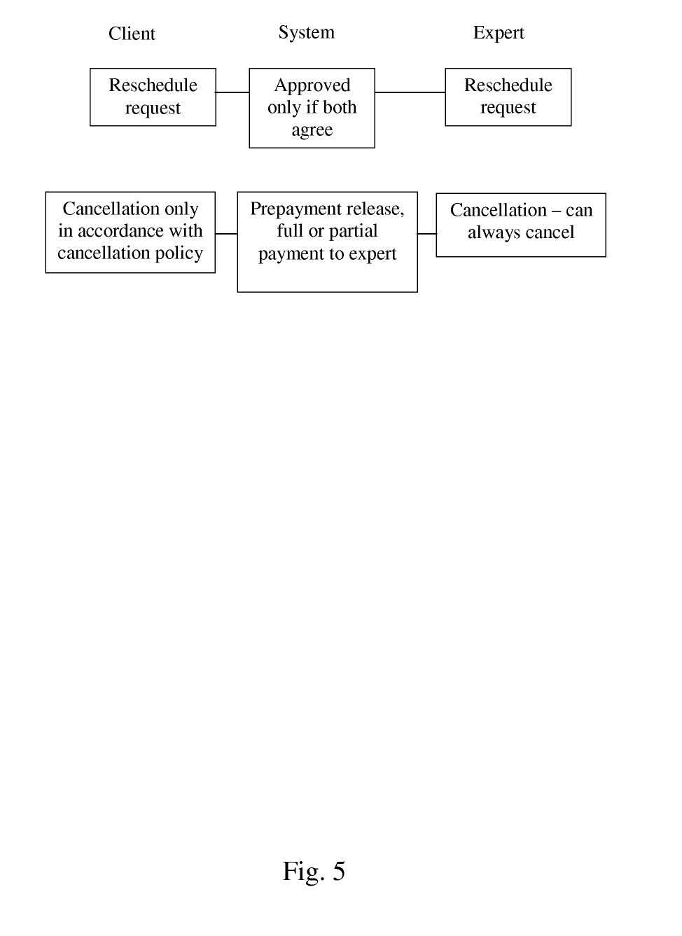

The cancellation/rescheduling policy is shown in FIG. 5. Here the system mediates rescheduling requests by approving the request only if both parties agree. The payment policy depends upon the time of cancellation and by whom the cancellation was made. If the cancellation by the client is before the meeting, the prepayment is released and full or partial payment to the expert is made from this prepayment. The expert on the other hand can always cancel.

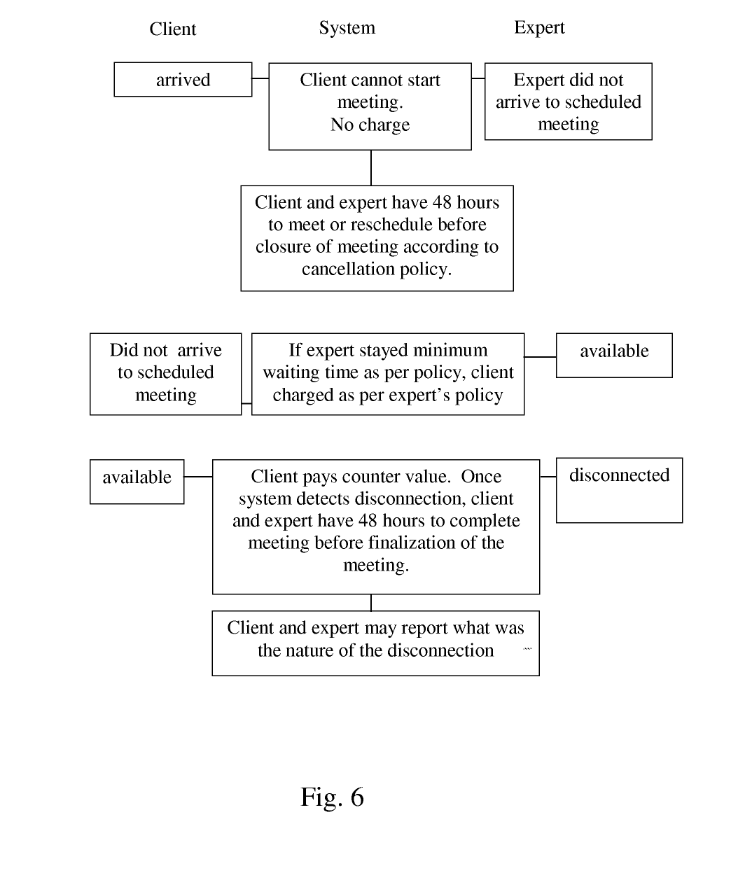

Various policies dealing with no-shows and disconnections are disclosed in FIG. 6. As seen in the FIG. 1f the client arrives to a scheduled meeting but the expert does not, the client cannot call the meeting and no charge is made. The client and expert have a certain time such as 48 hours in this example, within which to either meet or reschedule, before the system will close the meeting in accordance to the cancellation policy.

If on the other hand the client does not arrive to a scheduled meeting while the expert does arrive, then a conditional policy is implemented as follows: If the expert stayed the minimum waiting duration as appears in his policy, then the client will be charged as appears in the expert's policy. Otherwise, a different policy may be implemented such as that the client is not charged or the expert may allow a rescheduling in the following 48 hours, for example.

If the client is disconnected but the expert is available, the client will be required by the system to pay the higher of the counter value or the cancellation policy. In certain embodiments of the invention, the client and expert may have 48 hours of grace period to reconnect or reschedule.

If the client is available but the expert disconnects, the client will pay only the counter value (until disconnection) and they will be given a certain grace period such as 48 hours in this example to complete the meeting. The client and expert may in these cases report the nature of the disconnection. In certain embodiments of the invention, the client and expert may have 48 hours of grace period to reconnect or reschedule.

If the expert stops the meeting in the middle of its duration then the immediate charge amount will be the counter state.

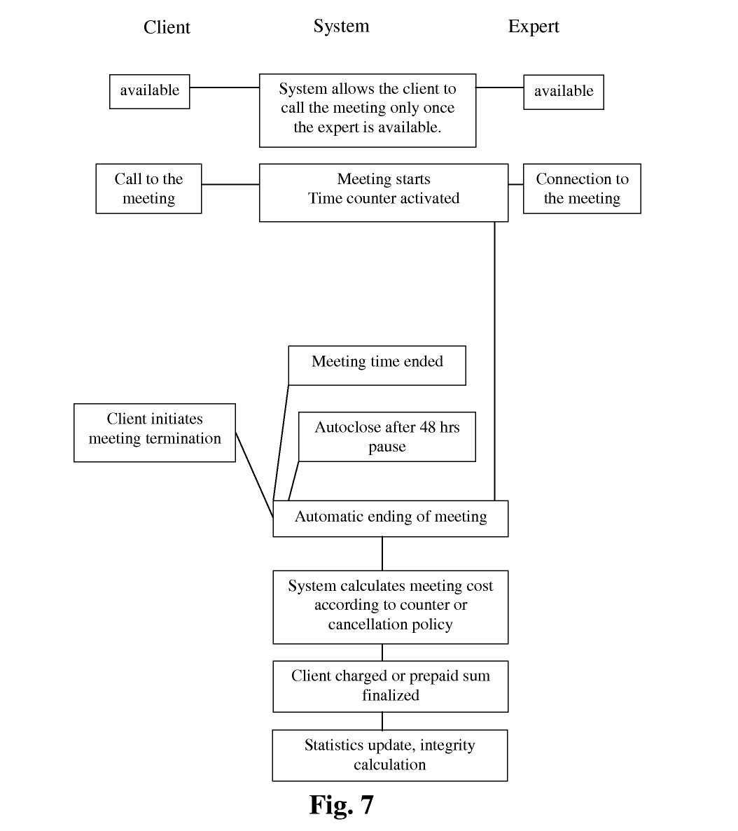

As detailed in FIG. 7, in the happy event that the client and expert are both available for their planned meeting, the system will go through a sequence of operations. Firstly it will allow the client to call the meeting to session once the expert is available. The meeting starts at that point, and the counter is activated. The meeting may be automatically ended when the scheduled meeting time has elapsed, or if the client or expert stops the meeting. In the case of an unexpected termination of the meeting it will be considered as paused meeting as described above and the meeting will be automatically closed after a grace period such as 48 hours. The system will calculate the meeting cost in all these cases in accordance with the cancellation policy and in respect of the counter value.

The system may allow a grace period, for example of 48 hours, before the actual charge in all cases other than if the client or expert stops the meeting or the meeting ended as scheduled.

Once the meeting cost has been calculated the client is charged or the prepaid sum is finalized and money is transferred to the expert. Thereupon the statistics are updated, and an integrity calculation made based on the meeting duration, appearances of the client and expert, disconnections and the like.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A meeting marketplace comprising:
a. a networked server having a database of experts and clients;
b. each client and expert having account and card;
c. means for allowing clients and experts to search said database for clients and experts;
d. means for allowing clients and experts to determine specific meeting price and policy by means of meeting proposal;
e. means for allowing virtual meetings between experts and clients according to the meeting policy;
f. means for allowing of an automated protection and enforcement meeting policy;
g. means for billing said clients and payments to said experts according to the specific meeting price and policy;
whereby clients and experts can perform said meeting by means of an online marketplace.

2. The system of claim 1 wherein said means for allowing clients and experts to determine specific meeting price and policy by means of meeting proposal comprise of:
a. Means for allowing said client and expert to propose a meeting to one another;
b. Means for allowing said client and expert to negotiate meeting policy, date, time and duration;
c. Means for allowing said client to prepay.

3. The system of claim 1 wherein each expert's account contain one client card and at least one expert card.

4. The system of claim 3 wherein the expert cards having one full credentials card and multiple limited credentials cards for allowing multiple experts to access said accounts.

5. The system of claim 1 wherein said meeting is selected from the group consisting of: webinar, webinar event, media license.

6. The system of claim 1 wherein said cards further comprising means for displaying related cards.

7. The system of claim 1 wherein said cards further comprising means for displaying the shared information with one's card.

8. The system of claim 1 further comprising means for calculating and displaying cards integrity score.

9. The system of claim 1 wherein said means for allowing of an automated protection and enforcement meeting policy comprise of:
a. Means for allowing said client to prepay;
b. Means for keeping the prepayment as trustee for said client and expert;
c. Means for tracking and logging said implementation of the meeting;
d. Means for comparing and automated resolution of said implementation of the meeting with said meeting policy;
e. Means for distributing the payment as per the meeting policy and actual implementation of the meeting.

10. The system of claim 1 wherein said meeting is prearranged and performed after said client and expert negotiated said meeting policy.

11. A method of connecting experts with clients comprising steps of:
a. providing a networked server having a database of experts and clients;
b. providing each client and expert having account and card;
c. allowing clients and experts to search said database for clients and experts;
d. allowing clients and experts to determine specific meeting price and policy by allowing of meeting proposal;
e. allowing virtual meetings between experts and clients according to the meeting policy;
f. allowing of an automated protection and enforcement meeting policy;
g. billing said clients and payments to said experts according to the specific meeting price and policy;
whereby clients and experts can perform said meeting by means of an online marketplace.

12. The method of claim 11 wherein said means for allowing clients and experts to determine specific meeting price and policy by means of meeting proposal comprise of:
a. allowing said client and expert to propose a meeting to one another;
b. allowing said client and expert to negotiate meeting policy, date, time and duration;
c. allowing said client to prepay.

13. The method of claim 11 wherein each expert's account contain one client card and at least one expert card.

14. The method of claim 13 wherein the expert cards having one full credentials card and multiple limited credentials cards for allowing multiple experts to access said accounts.

15. The method of claim 11 wherein said meeting is selected from the group consisting of: webinar, webinar event, media license.

16. The method of claim 11 wherein said cards further comprising means for displaying related cards.

17. The method of claim 11 wherein said cards further comprising means for displaying the shared information with one's card.

18. The method of claim 11 further comprising means for calculating and displaying cards integrity score.

19. The method of claim 11 wherein said means for allowing of an automated protection and enforcement meeting policy comprise of:
a. Means for allowing said client to prepay;
b. Means for keeping the prepayment as trustee for said client and expert;
c. Means for tracking and logging said implementation of the meeting;
d. Means for comparing and automated resolution of said implementation of the meeting with said meeting policy;
e. Means for distributing the payment as per the meeting policy and actual implementation of the meeting.

20. The method of claim 1 wherein said meeting is prearranged and performed after said client and expert negotiated said meeting policy.
